(19) United States
(12) Patent Application Publication
(10) Pub. No.: US 2025/0044897 A1
(43) Pub. Date: Feb. 6, 2025

(54) TOUCH PANEL AND TOUCH DISPLAY DEVICE

(71) Applicant: KUNSHAN GO-VISIONOX OPTO-ELECTRONICS CO., LTD, Kunshan (CN)

(72) Inventor: Yichao DENG, Kunshan (CN)

(73) Assignee: KUNSHAN GO-VISIONOX OPTO-ELECTRONICS CO., LTD, Kunshan (CN)

(21) Appl. No.: 18/920,131

(22) Filed: Oct. 18, 2024

Related U.S. Application Data
(63) Continuation of application No. 18/168,809, filed on Feb. 14, 2023.
Application No. 18/168,809 is a continuation of application No. PCT/CN2021/115200, filed on Aug. 30, 2021.

(30) Foreign Application Priority Data
Nov. 13, 2020 (CN) 202011270175.6

(51) Int. Cl. G06F 3/041; G06F 3/044

(52) U.S. Cl. CPC G06F 3/0418; G06F 3/0443

(57) ABSTRACT

A touch panel and a touch display device. The touch panel includes a plurality of touch electrodes disposed in the same layer. A touch electrode includes a touch sensing region and a capacitance adjustment region. The touch sensing region is configured to transmit a touch signal. The capacitance adjustment region is configured to reduce at least one of capacitance-to-ground of the touch electrode or coupling capacitance between two adjacent touch electrodes.

### CROSS-REFERENCE TO RELATED APPLICATIONS

This is a Continuation Application of US patent application U.S. Ser. No. 18/168,809 which is a Continuation Application of International Patent Application No. PCT/CN2021/115200, filed on Aug. 30, 2021, which claims priority to Chinese Patent Application No. 202011270175.6 filed on Nov. 13, 2020, the disclosures of which are incorporated herein by reference in their entireties.

### TECHNICAL FIELD

The present application relates to the field of display panel technologies and, in particular, to a touch panel and a touch display device.

### BACKGROUND

With the development of touch technologies and the improvement of people's living standards, touch display devices have been widely applied. The thickness of a touch display device is increasingly thin. The distance between a touch panel and a display panel is increasingly small. In this case, the coupling capacitance of the touch panel to the display panel increases, which increases the influence of the noise of the display panel on the touch panel and affects the touch effect of the product.

### SUMMARY

Embodiments of the present application provide a touch panel and a display device to reduce the influence of the noise of the display panel on the touch panel and resolve the issue that the touch control of the touch panel is insensitive or fails.

In a first aspect, embodiments of the present application provide a touch panel. The touch panel includes a plurality of touch electrodes disposed in the same layer.

A touch electrode includes a touch sensing region and a capacitance adjustment region.

The touch sensing region is configured to transmit a touch signal. The capacitance adjustment region is configured to reduce at least one of capacitance-to-ground of the touch electrode or coupling capacitance between two adjacent touch electrodes.

In a second aspect, embodiments of the present application provide a touch display device. The touch display device includes a layered display panel and a touch panel. The touch panel comprises a plurality of touch electrodes disposed in a same layer. A touch electrode comprises a touch sensing region and a capacitance adjustment region. The touch sensing region is configured to transmit a touch signal, and the capacitance adjustment region is configured to reduce at least one of capacitance-to-ground of the touch electrode or coupling capacitance between two adjacent touch electrodes.

According to embodiments of the present application, the touch panel includes a plurality of touch electrodes disposed in the same layer, a touch electrode includes a touch sensing region and a capacitance adjustment region, the touch sensing region is configured to transmit a touch signal, and the capacitance adjustment region is configured to reduce the capacitance-to-ground of the touch electrode and/or the coupling capacitance between two adjacent touch electrodes. The touch signal is transmitted through the touch sensing region of the touch electrode, and the arrangement of the capacitance adjustment region of the touch electrode reduces the area of the entire touch electrode, guaranteeing that the touch electrode has relatively small capacitance-to-ground, or reducing the coupling capacitance between two adjacent touch electrodes; or guaranteeing that the touch electrode has relatively small capacitance-to-ground, meanwhile, the coupling capacitance between two adjacent touch electrodes is relatively small. The arrangement of the capacitance adjustment region reduces the area of the touch electrode, reduces the coupling capacitance between adjacent touch electrodes, and thereby reduces the noise of a display panel coupled to the touch panel. Since a touch sensing signal is a signal generated by a finger touching the touch panel, the touch sensing signal is unchanged, so that the signal-to-noise ratio of a touch signal of the touch panel is relatively high, the capacitance-to-ground of the touch electrode is reduced, the noise of the display panel coupled to the touch panel is reduced. Therefore, the touch panel has relatively high touch sensitivity, the influence of the noise of the display panel on the touch panel is reduced, and the issue that the touch control of the touch panel is insensitive or fails is resolved.

### BRIEF DESCRIPTION OF DRAWINGS

FIG. 1 is a structural view of a touch panel according to an embodiment of the present application.

FIG. 2 is a structural view of another touch panel according to an embodiment of the present application.

FIG. 3 is a structural view of another touch panel according to an embodiment of the present application.

FIG. 4 is a structural view of another touch panel according to an embodiment of the present application.

FIG. 5 is a structural view of another touch panel according to an embodiment of the present application.

FIG. 6 is a structural view of another touch panel according to an embodiment of the present application.

FIG. 7 is a graph illustrating that capacitance-to-ground of a touch electrode and coupling capacitance vary with a first width.

FIG. 8 is a structural view of another touch panel according to an embodiment of the present application.

FIG. 9 is a structural view of another touch panel according to an embodiment of the present application.

FIG. 10 is a structural view of another touch panel according to an embodiment of the present application.

FIG. 11 is a structural view of another touch panel according to an embodiment of the present application.

FIG. 12 is a structural view of another touch panel according to an embodiment of the present application.

FIG. 13 is a structural view of another touch panel according to an embodiment of the present application.

FIG. 14 is a graph illustrating that capacitance-to-ground C_{pY} of a first electrode and capacitance-to-ground C_{pX} of a second electrode vary with a third width of D₃ and a third width of D₃′ according to an embodiment of the present application.

FIG. 15 is a graph illustrating that coupling capacitance Cₘ between a first electrode and a second electrode varies with a third width of D₃ and a third width of D₃′ according to an embodiment of the present application.

FIG. 16 is a graph illustrating that capacitance-to-ground C_{pY} of a first electrode and capacitance-to-ground C_{pX} of a second electrode vary with a third width of D₁, a third width of D₁′, a third width of D₀, a third width of D₀′, a third width of D₂, and a third width of D₂′ according to an embodiment of the present application.

FIG. 17 is a graph illustrating that coupling capacitance Cₘ between a first electrode and a second electrode varies with a third width of D₁, a third width of D₁′, a third width of D₀, a third width of D₀′, a third width of D₂, and a third width of D₂′ according to an embodiment of the present application.

FIG. 18 is a graph illustrating that capacitance-to-ground C_{pY} of a first electrode and capacitance-to-ground C_{pX} of a second electrode vary with a third width of D₁, a third width of D₁′, a third width of D₀, a third width of D₀′, a third width of D₂, a third width of D₂′, a third width of D₃, and a third width of D₃′ according to an embodiment of the present application.

FIG. 19 is a graph illustrating that coupling capacitance Cₘ between a first electrode and a second electrode varies with a third width of D₁, a third width of D₁′, a third width of D₀, a third width of D₀′, a third width of D₂, a third width of D₂′, a third width of D₃, and a third width of D₃′ according to an embodiment of the present application.

FIG. 20 is a structural view of a touch display device according to an embodiment of the present application.

### DETAILED DESCRIPTION

Hereinafter the present application is described in detail in conjunction with the drawings and embodiments.

As mentioned in the background, the distance between a touch panel and a display panel is increasingly small, causing the coupling capacitance of the touch panel to the display panel to increase. The noise of the display panel to the touch panel increases, causing the signal-to-noise ratio of a touch signal of the touch panel to decrease, leading to the issue that the touch control of the touch panel is insensitive or fails, and affecting the touch effect of a touch product.

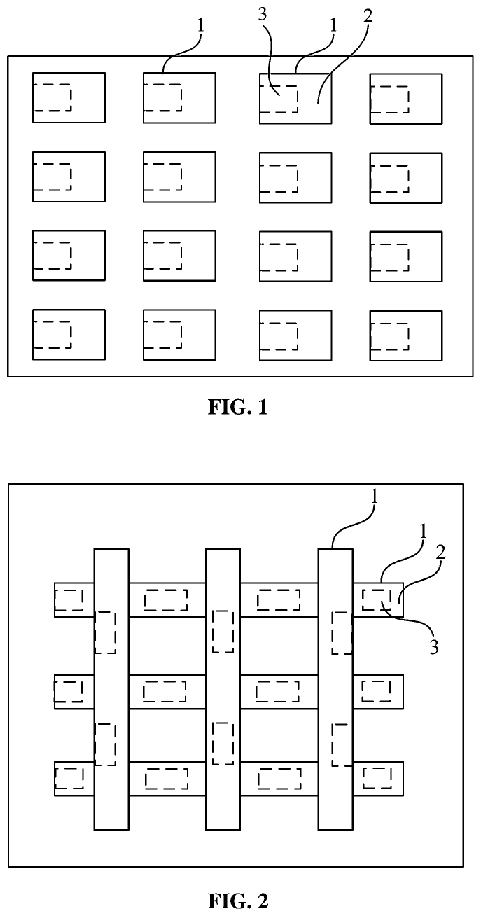

FIG. 1 is a structural view of a touch panel according to an embodiment of the present application. Referring to FIG. 1, the touch panel according to this embodiment of the present application includes a plurality of touch electrodes 1 disposed in the same layer. A touch electrode 1 includes a touch sensing region 2 and a capacitance adjustment region 3. The touch sensing region 2 is configured to transmit a touch signal. The capacitance adjustment region 3 is configured to reduce the capacitance-to-ground of the touch electrode 1 and/or the coupling capacitance between two adjacent touch electrodes 1.

The plurality of touch electrodes 1 are disposed in the same layer, reducing the thickness of the touch panel and facilitating the reduction of the thickness of the display device. The capacitance adjustment region 3 may be hollowed out. The capacitance adjustment region 3 may be filled with an insulating layer or may be provided with a floating electrode inside. The floating electrode is not connected to and is insulated with an adjacent touch electrode. The capacitance adjustment region 3 may reduce the area of the entire touch electrode 1. The capacitance-to-ground may be formed between the touch electrode 1 and the display panel. For example, the capacitance-to-ground may be formed between the touch electrode 1 and a cathode of the display panel. The coupling capacitance exists between two adjacent touch electrodes 1. In this case, the arrangement of the capacitance adjustment region 3 which is hollowed out reduces the area of the touch electrode 1, reducing the capacitance-to-ground of the touch electrode 1, improving the touch sensitivity of the touch panel, reducing the coupling capacitance between adjacent touch electrodes 1, reducing a noise signal in the touch signal, and thereby improving the signal-to-noise ratio of the touch signal of the touch panel.

Exemplarily, the touch panel may be a self-capacitance touch panel or a mutual capacitance touch panel. FIG. 1 exemplarily illustrates the case where the touch panel is a self-capacitance touch panel. Referring to FIG. 1, the touch panel may be set as a self-capacitance touch panel. The capacitance-to-ground may be generated between the touch electrode 1 and the ground. The arrangement of the capacitance adjustment region 3 reduces the area of the touch electrode 1, reducing the capacitance-to-ground of the touch electrode 1, thereby reducing the noise of the display panel coupled to the touch panel, and improving the touch sensitivity of the touch panel.

FIG. 2 is a structural view of another touch panel according to an embodiment of the present application. FIG. 2 exemplarily illustrates the case where the touch panel is a mutual capacitance touch panel. Referring to FIG. 2, the touch panel may be set as a mutual capacitance touch panel. The touch electrodes 1 includes a first electrode and a second electrode. The coupling capacitance may be generated between adjacent touch electrodes 1. The capacitance-to-ground may also be generated between the touch electrode 1 and the ground. The arrangement of the capacitance adjustment region 3 reduces the area of the touch electrode 1, reducing the coupling capacitance between adjacent touch electrodes 1 and thereby reducing the noise of the display panel coupled to the touch panel. Since a touch sensing signal is a signal generated by a finger touching the touch panel, the touch sensing signal is unchanged, so that the signal-to-noise ratio of the touch signal of the touch panel can be relatively high, the capacitance-to-ground of the touch electrode 1 can be reduced, the noise of the display panel coupled to the touch panel can be reduced, and thereby the touch panel has relatively high touch sensitivity. It is to be noted that FIG. 2 does not illustrate a bridge between mutual capacitance touch electrodes 1.

The touch panel according to this embodiment transmits the touch signal through the touch sensing region of the touch electrode, and the arrangement of the capacitance adjustment region of the touch electrode guarantees that the touch electrode has relatively small capacitance-to-ground, or reduces the coupling capacitance between two adjacent touch electrodes, or guarantees that the touch electrode has both relatively small capacitance-to-ground and relatively small coupling capacitance, reducing the influence of the noise of the display panel on the touch panel, improving the touch sensitivity of the touch sensing region of the touch electrode, making the signal-to-noise ratio of the touch signal of the touch panel relatively high, resolving the issue that the touch control of the touch panel is insensitive or fails.

In an embodiment, FIG. 3 is a structural view of another touch panel according to an embodiment of the present application. On the basis of the preceding embodiments, referring to FIG. 3, the capacitance adjustment region 3 is provided with an invalid electrode 4. The invalid electrode 4 is disposed in the same layer as the touch electrode 1 and is floated.

The invalid electrode 4 is disposed in the same layer as the touch electrode 1, so that the thickness of the touch panel may not increase. The invalid electrode 4 is floated, that is, the invalid electrode 4 is not connected to and is insulated with an adjacent touch electrode 1. In this case, the capacitance-to-ground cannot be generated between the invalid electrode 4 and the ground, and the coupling capacitance cannot be generated between the invalid electrode 4 and the adjacent touch electrode 1. Accordingly, the touch panel has a relatively small coupling capacitance and capacitance-to-ground. Additionally, since the touch electrode 1 is adjacent to a transparent cover plate, the arrangement in which the invalid electrode 4 is disposed in the capacitance adjustment region 3 may form an even metal layer in a layer where the touch electrode 1 is located so that grids formed by the capacitance adjustment region 3 of the touch electrode 1 and the touch sensing region 2 of the touch electrode 1 are not easily seen, making the touch panel have relatively good visual aesthetics.

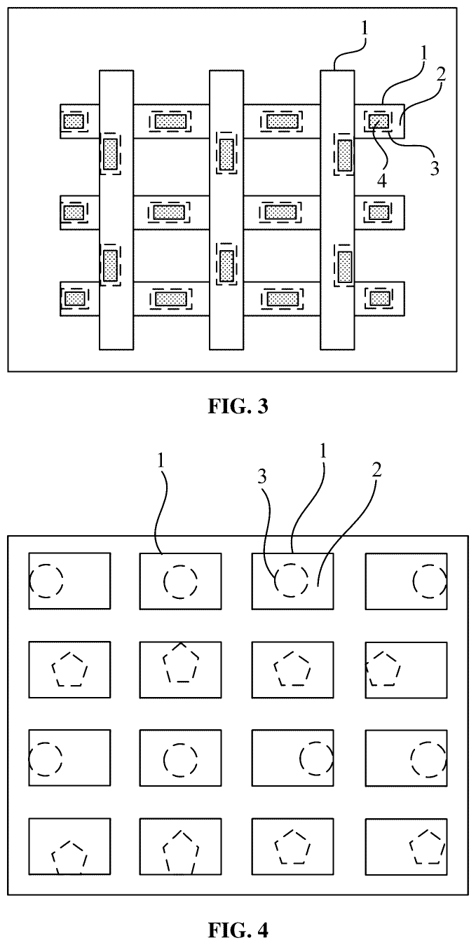

In an embodiment, FIG. 4 is a structural view of another touch panel according to an embodiment of the present application. On the basis of the preceding embodiments, referring to FIG. 4, the touch sensing region 2 is disposed around the capacitance adjustment region 3.

Such an arrangement guarantees a relatively small coupling capacitance of the touch sensing region 2 and enables a signal transmission path of the touch sensing region 2 to form a closed loop, improving the strength of the touch sensing signal and thereby improving the signal-to-noise ratio of the touch sensing signal.

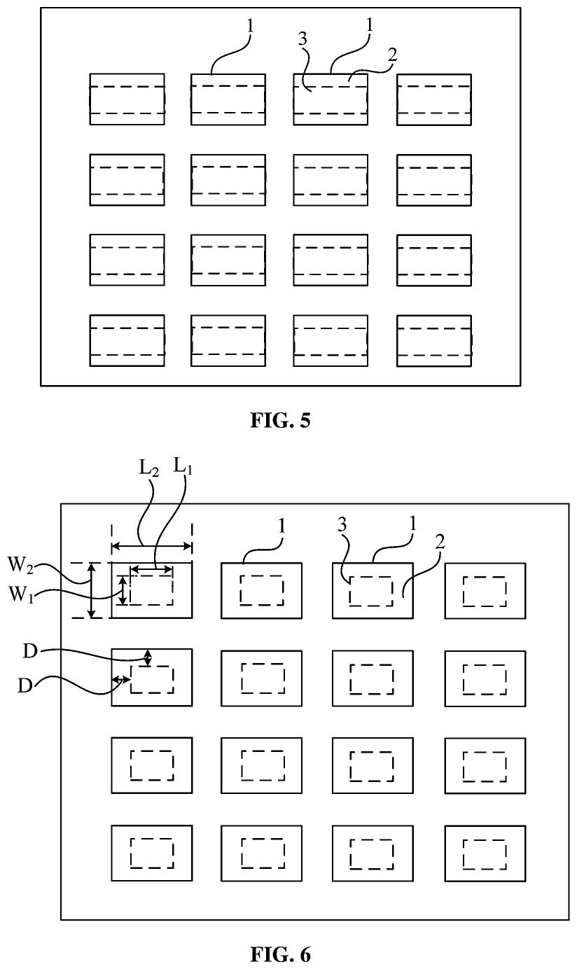

In an embodiment, the shape of the touch electrode 1 may be at least one of a rectangular block, a strip, a triangle, or another irregular shape and may be set according to actual needs of the touch panel. The shape of the capacitance adjustment region 3 may be the same as or different from the shape of the touch electrode 1. FIG. 4 exemplarily illustrates the case where the shape of the capacitance adjustment region 3 is different from the shape of the touch electrode 1 and where a plurality of capacitance adjustment regions 3 have different shapes. The shape of the capacitance adjustment region 3 and the shape of the touch electrode 1 may be set according to needs and are not limited here. FIG. 5 is a structural view of another touch panel according to an embodiment of the present application. On the basis of the preceding embodiments, FIG. 5 exemplarily illustrates the case where the shape of the capacitance adjustment region 3 is the same as the shape of the touch electrode 1. The shape of the capacitance adjustment region 3 is set to be the same as the shape of the touch electrode 1. In this case, when the touch electrode 1 is manufactured, the touch sensing region 2 is more easily disposed around the capacitance adjustment region 3, facilitating the manufacture of the touch electrode 1.

In an embodiment, FIG. 6 is a structural view of another touch panel according to an embodiment of the present application. On the basis of the preceding embodiments, referring to FIG. 6, a first length L₁ of the capacitance adjustment region 3 is smaller than a second length L₂ of the touch sensing region 2. The first length L₁ is the size of a long side of the capacitance adjustment region 3. The second length L₂ is the size of a long side of the touch sensing region 2. A first width W₁ of the capacitance adjustment region 3 is smaller than a second width W₂ of the touch sensing region 2. The first width W₁ is the size of a short side of the capacitance adjustment region 3. The second width W₂ is the size of a short side of the touch sensing region 2.

Such an arrangement enables the signal transmission path of the touch sensing region 2 to form a closed loop and makes the transmission of the touch sensing signal on the touch electrode 1 more even, improving the strength of the touch sensing signal, reducing the loss of the touch sensing signal in the transmission process, improving the signal-to-noise ratio of the touch sensing signal, and improving the touch effect of the touch panel.

In an embodiment, on the basis of the preceding embodiments, referring to FIG. 6, a distance D between a side of the touch sensing region 2 adjacent to a side of the capacitance adjustment region 3 and the corresponding side of the capacitance adjustment region 3 is greater than or equal to 50 μm. The first width W₁ is in the range of 150 μm to 300 μm.

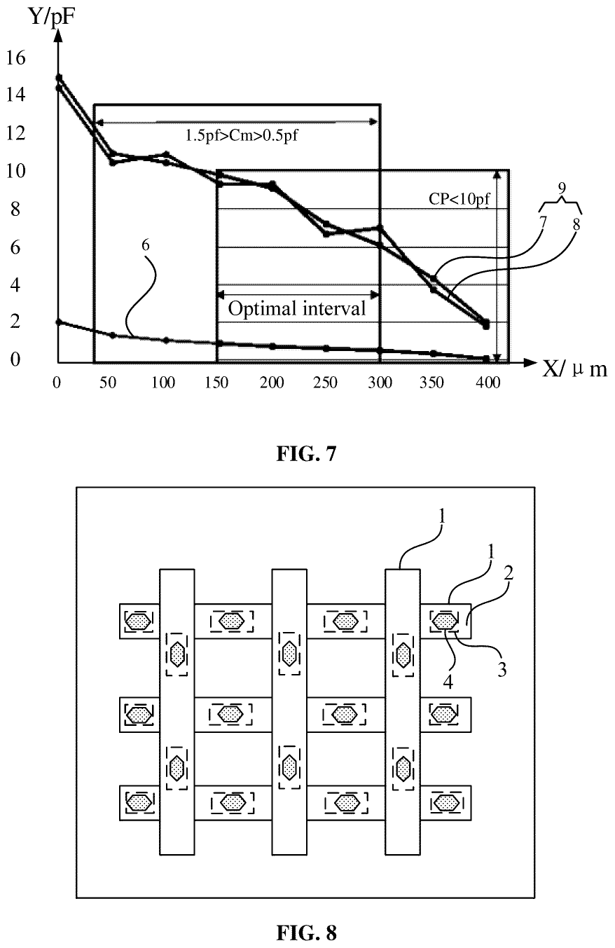

The excessively large capacitance-to-ground of the touch electrode 1 and the excessively large coupling capacitance may amplify the noise and thereby reduce the signal-to-noise ratio of the touch sensing signal. The excessively small capacitance-to-ground of the touch electrode 1 and the excessively small coupling capacitance may affect the strength of the touch sensing signal and affect the sensitivity of touch sensing. Thus, the first length L₁ of the capacitance adjustment region 3 may be set to be unchanged, and the first width W₁ is set to be in the range of 150 μm to 300 μm, for example, 180 μm, 200 μm, 220 μm, or 250 μm. In this case, the capacitance-to-ground of the touch electrode 1 and the coupling capacitance are each in the appropriate range, guaranteeing that the touch electrode 1 has a relatively high signal-to-noise ratio and improving the touch sensitivity of the touch panel. Exemplarily, FIG. 7 is a graph illustrating that the capacitance-to-ground of the touch electrode and the coupling capacitance vary with the first width. Referring to FIG. 7, an X axis represents the first width W₁, and a Y axis represents a capacitance value. When the first width W₁ is greater than 50 μm and smaller than 300 μm, the coupling capacitance 6 (referring to curve 6 in FIG. 7) between adjacent touch electrodes 1 is greater than 0.5 pF and smaller than 1.5 pF. When the coupling capacitance is excessively small, the touch signal is difficult to identify in the case of a relatively small variation of the touch signal. When the coupling capacitance is excessively large, the noise is relatively large, the relative noise of the touch signal is relatively small, and the signal-to-noise ratio of the touch signal is relatively low. When the first width W₁ is greater than 150 μm and smaller than 400 μm, the capacitance-to-ground 9 (referring to curve 9 in FIG. 7) of the touch electrode 2 is smaller than 10 pF, resulting in relatively small capacitance-to-ground and relatively small noise of the touch signal. The first width W₁ is set to be in the range of 150 μm to 300 μm, enabling the coupling capacitance and the capacitance-to-ground to be each in the appropriate range, guaranteeing a relatively high sensitivity of the touch sensing signal, and improving the touch effect.

In an embodiment, FIG. 8 is a structural view of another touch panel according to an embodiment of the present application. On the basis of the preceding embodiments, referring to FIG. 8, the shape of the invalid electrode 4 may include at least one of a rectangle, a triangle, a regular hexagon, or a circle.

The shape of the invalid electrode 4 may be set according to the shape of the capacitance adjustment region 3 and may also be set according to the needs of the touch sensing signal. It is to be noted that FIG. 8 exemplarily illustrates the case where the invalid electrode 4 is a hexagon, which is not a limit to the invalid electrode 4.

In an embodiment, the capacitance adjustment region 3 may be located at an edge of the touch sensing region 2.

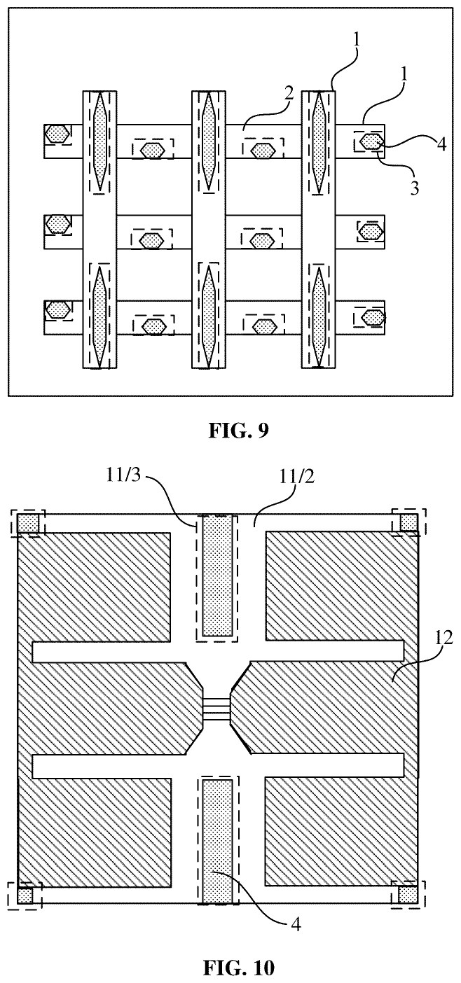

FIG. 9 is a structural view of another touch panel according to an embodiment of the present application. On the basis of the preceding embodiments, referring to FIG. 9, the capacitance adjustment region 3 is disposed at the edge of the touch sensing region 2 so that the invalid electrode 4 is also disposed at the edge of the touch sensing region 2, not affecting the transmission of the touch sensing signal in a main position of the touch sensing region 2. The arrangement in which the capacitance adjustment region 3 is disposed at the edge of the touch sensing region 2 may reduce the number of sides of the capacitance adjustment region 3 adjacent to the touch sensing region 2. When the invalid electrode 4 is manufactured in the capacitance adjustment region 3, the insulation between the invalid electrode 4 and the touch electrode 1 is more easily implemented, facilitating the manufacture of the invalid electrode 4.

In an embodiment, the touch panel may be a mutual capacitance touch panel or a self-capacitance touch panel. The touch panel may be a mutual capacitance touch panel. The touch electrodes 1 include a first electrode 11 and a second electrode 12. The first electrode 11 includes the touch sensing region 2 and the capacitance adjustment region 3; and/or the second electrode 12 includes the touch sensing region 2 and the capacitance adjustment region 3.

FIG. 10 is a structural view of another touch panel according to an embodiment of the present application. On the basis of the preceding embodiments, referring to FIGS. 7 and 10, the touch panel is a mutual capacitance touch panel. The touch electrodes 1 include the first electrode 11 and the second electrode 12. The first electrode 11 includes the touch sensing region 2 and the capacitance adjustment region 3. Such an arrangement reduces the area of the first electrode 11, reducing the capacitance-to-ground 7 of the first electrode 11, reducing the coupling capacitance 6 between the first electrode 11 and the second electrode 12, reducing the noise of the touch sensing signal, thereby reducing the noise of the display panel coupled to the touch panel, and improving the touch sensitivity of the touch panel.

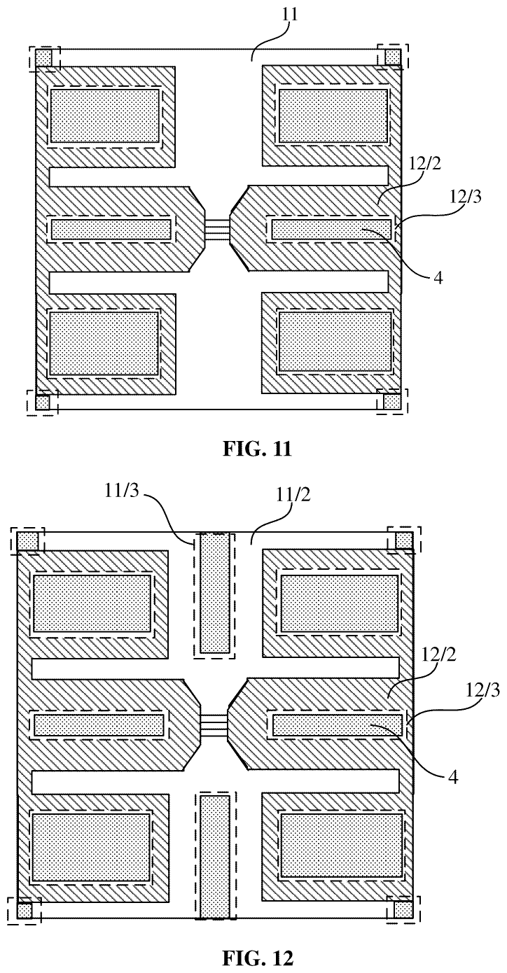

FIG. 11 is a structural view of another touch panel according to an embodiment of the present application. On the basis of the preceding embodiments, referring to FIGS. 7 and 11, the touch panel is a mutual capacitance touch panel. The touch electrodes 1 include the first electrode 11 and the second electrode 12. The second electrode 12 includes the touch sensing region 2 and the capacitance adjustment region 3. Such an arrangement reduces the area of the second electrode 12, reducing the capacitance-to-ground 8 of the second electrode 12, reducing the coupling capacitance 6 between the second electrode 12 and the first electrode 11, thereby reducing the noise of the display panel coupled to the touch panel, and improving the touch sensitivity of the touch panel.

FIG. 12 is a structural view of another touch panel according to an embodiment of the present application. On the basis of the preceding embodiments, referring to FIGS. 7 and 12, the touch panel is a mutual capacitance touch panel. The touch electrodes 1 include the first electrode 11 and the second electrode 12. The first electrode 11 includes the touch sensing region 2 and the capacitance adjustment region 3, and the second electrode 12 includes the touch sensing region 2 and the capacitance adjustment region 3. Such an arrangement reduces the area of the first electrode 11 and the area of the second electrode 12, reducing the capacitance-to-ground 7 of the first electrode 11 and the capacitance-to-ground 8 of the second electrode 12 respectively, reducing the coupling capacitance 6 between the second electrode 12 and the first electrode 11, thereby reducing the noise of the display panel coupled to the touch panel, improving the signal-to-noise ratio of the touch sensing signal greatly in the case where the touch sensing signal is unchanged, improving the touch sensitivity of the touch panel, reducing the effect of the noise of the display panel on the touch panel, and resolving the issue that the touch control of the touch panel is insensitive or fails.

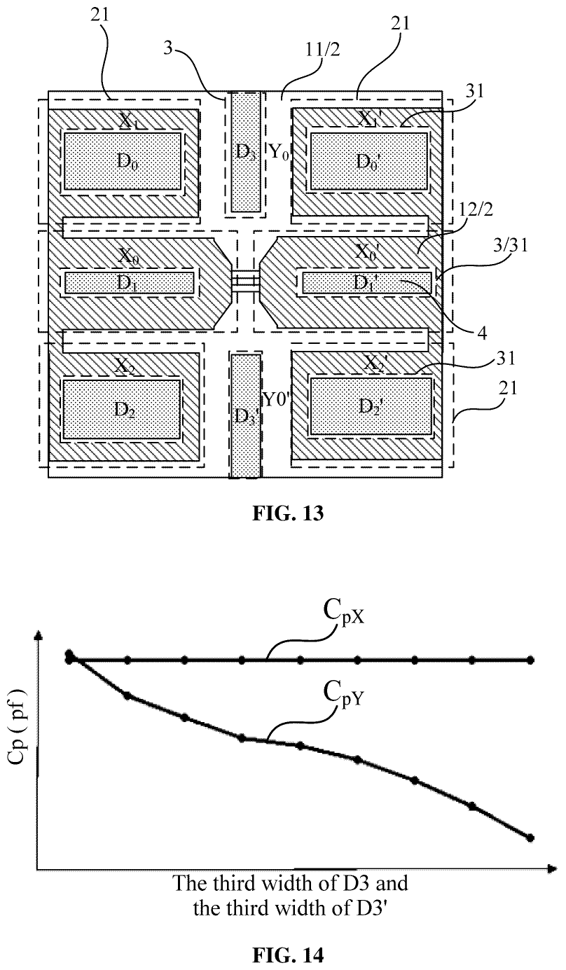

In an embodiment, FIG. 13 is a structural view of another touch panel according to an embodiment of the present application. On the basis of the preceding embodiments, referring to FIG. 13, the touch sensing region 2 includes at least two touch sensing sub-regions 21, the capacitance adjustment region 3 includes at least two capacitance adjustment sub-regions 31, and each touch sensing sub-region 21 is correspondingly provided with at least one capacitance adjustment sub-region 31.

Each touch sensing sub-region 21 is correspondingly provided with at least one capacitance adjustment sub-region 31. In this case, the capacitance-to-ground of each touch sensing sub-region 21 can be reduced so that the capacitance-to-ground of the touch sensing region 2 composed of a plurality of touch sensing sub-regions 21 is as small as possible, improving the signal-to-noise ratio of the touch sensing signal and enabling each region of the touch panel to have a relatively good touch effect. It is to be noted that FIG. 13 exemplarily illustrates the case where each touch sensing sub-region 21 is correspondingly provided with one capacitance adjustment sub-region 31. Each touch sensing sub-region 21 may also be correspondingly provided with a plurality of capacitance adjustment sub-regions 31, which is not repeated here.

Exemplarily, referring to FIG. 13, the first electrode 11 may include two touch sensing sub-regions 21, that is, a first touch sensing sub-region Y₀ and a second touch sensing sub-region Y₀′. The second electrode 12 may include six touch sensing sub-regions 21, that is, a third touch sensing sub-region X₀, a fourth touch sensing sub-region X₀′, a fifth touch sensing sub-region X₁, a sixth touch sensing sub-region X₁′, a seventh touch sensing sub-region X₂, and an eighth touch sensing sub-region X₂′. Each touch sensing sub-region 21 may be correspondingly provided with one capacitance adjustment sub-region 31. Moreover, each capacitance adjustment sub-region 31 may include one invalid electrode 4. Referring to FIG. 13, the first touch sensing sub-region Y₀ and the second touch sensing sub-region Y₀′ are correspondingly provided with a first invalid electrode D₃ and a second invalid electrode D₃′ respectively. The third touch sensing sub-region X₀ and the fourth touch sensing sub-region X₀′ are correspondingly provided with a third invalid electrode D₁ and a fourth invalid electrode D₁′ respectively. The fifth touch sensing sub-region X₁ and the sixth touch sensing sub-region X₁′ are correspondingly provided with a fifth invalid electrode D₀ and a sixth invalid electrode D₀′ respectively. The seventh touch sensing sub-region X₂ and the eighth touch sensing sub-region X₂′ are correspondingly provided with a seventh invalid electrode D₂ and an eighth invalid electrode D₂′ respectively.

A third width of the first invalid electrode D₃, a third width of the second invalid electrode D₃′, a third width of the third invalid electrode D₁, a third width of the fourth invalid electrode D₁′, a third width of the fifth invalid electrode D₀, a third width of the sixth invalid electrode D₀′, a third width of the seventh invalid electrode D₂ and a third width of the eighth invalid electrode D₂′ may be adjusted so as to adjust the area of corresponding invalid electrodes, thereby adjusting the area of the first electrode in a corresponding region and the area of the second electrode in a corresponding region, and thus adjusting the capacitance-to-ground between the first electrode and the second electrode as well as the coupling capacitance between the first electrode and the second electrode.

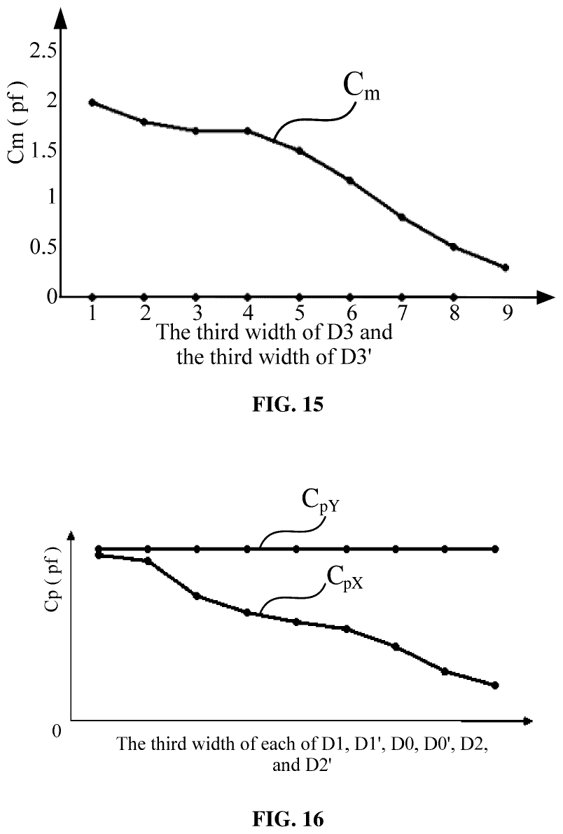

Exemplarily, FIG. 14 is a graph illustrating that the capacitance-to-ground C_{pY} of the first electrode and the capacitance-to-ground C_{pX} of the second electrode vary with the third width of D₃ and the third width of D₃′ according to an embodiment of the present application. FIG. 15 is a graph illustrating that the coupling capacitance Cₘ between the first electrode and the second electrode varies with the third width of D₃ and the third width of D₃′ according to an embodiment of the present application. On the basis of the preceding embodiments, referring to FIGS. 13 and 15, in the case where a third length of the first invalid electrode D₃ and a third length of the second invalid electrode D₃′ are unchanged, with the third width of the first invalid electrode D₃ and the third width of the second invalid electrode D₃′ increasing, the area of the first invalid electrode D₃ and the area of the second invalid electrode D₃′ increase. In this case, the area of the first touch sensing sub-region Y₀ of the first electrode 11 and the area of the second touch sensing sub-region Y₀′ of the first electrode 11 reduce, the capacitance-to-ground C_{pY} of the first electrode 11 reduces, the capacitance-to-ground C_{pX} of the second electrode 12 is constant, and the coupling capacitance Cₘ between the first electrode 11 and the second electrode 12 reduces.

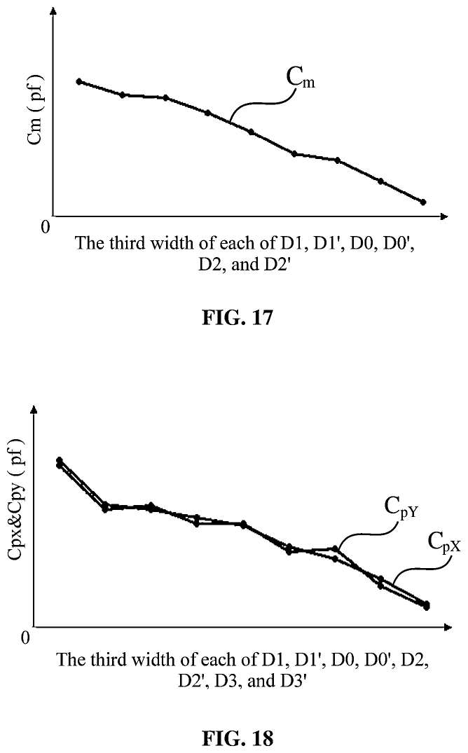

FIG. 16 is a graph illustrating that the capacitance-to-ground C_{pY} of the first electrode and the capacitance-to-ground C_{pX} of the second electrode vary with the third width of D₁, the third width of D₁′, the third width of D₀, the third width of D₀′, the third width of D₂, and the third width of D₂′ according to an embodiment of the present application. FIG. 17 is a graph illustrating that the coupling capacitance Cₘ between the first electrode and the second electrode varies with the third width of D₁, the third width of D₁′, the third width of D₀, the third width of D₀′, the third width of D₂, and the third width of D₂′ according to an embodiment of the present application. On the basis of the preceding embodiments, referring to FIGS. 13, 16, and 17, in the case where a third length of the third invalid electrode D₁, a third length of the fourth invalid electrode D₁′, a third length of the fifth invalid electrode D₀, a third length of the sixth invalid electrode D₀′, a third length of the seventh invalid electrode D₂, and a third length of the eighth invalid electrode D₂′ are unchanged, with the third width of the third invalid electrode D₁, the third width of the fourth invalid electrode D₁′, the third width of the fifth invalid electrode D₀, the third width of the sixth invalid electrode D₀′, the third width of the seventh invalid electrode D₂, and the third width of the eighth invalid electrode D₂′ increasing, the area of the third invalid electrode D₁, the area of the fourth invalid electrode D₁′, the area of the fifth invalid electrode D₀, the area of the sixth invalid electrode D₀′, the area of the seventh invalid electrode D₂, and the area of the eighth invalid electrode D₂′ increase. In this case, the area of the third touch sensing sub-region X₀ of the second electrode 12, the area of the fourth touch sensing sub-region X₀′ of the second electrode 12, the area of the fifth touch sensing sub-region X₁ of the second electrode 12, the area of the sixth touch sensing sub-region X₁′ of the second electrode 12, the area of the seventh touch sensing sub-region X₂ of the second electrode 12, and the area of the eighth touch sensing sub-region X₂′ of the second electrode 12 reduce; the capacitance-to-ground C_{pY} of the first electrode 11 is constant; the capacitance-to-ground C_{pX} of the second electrode 12 reduces; and the coupling capacitance Cₘ between the first electrode 11 and the second electrode 12 reduces.

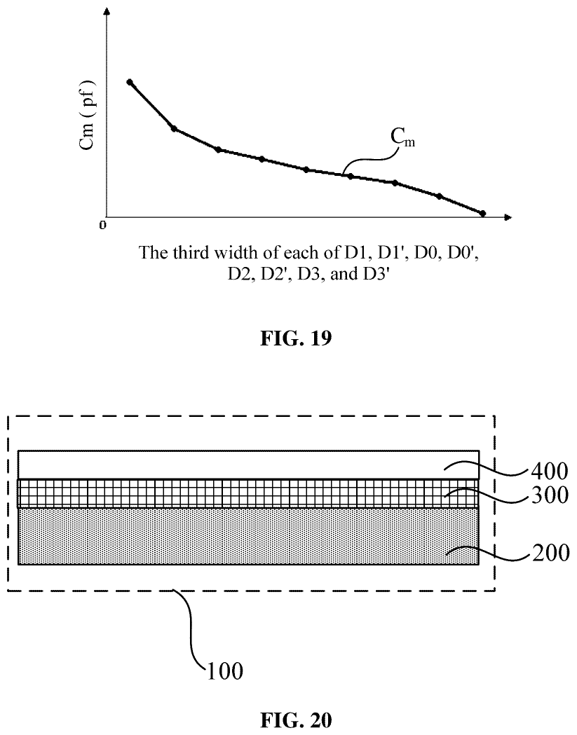

FIG. 18 is a graph illustrating that the capacitance-to-ground C_{pY} of the first electrode and the capacitance-to-ground C_{pX} of the second electrode vary with the third width of D₁, the third width of D₁′, the third width of D₀, the third width of D₀′, the third width of D₂, the third width of D₂′, the third width of D₃, and the third width of D₃′ according to an embodiment of the present application. FIG. 19 is a graph illustrating that the coupling capacitance Cₘ between the first electrode and the second electrode varies with the third width of D₁, the third width of D₁′, the third width of D₀, the third width of D₀′, the third width of D₂, the third width of D₂′, the third width of D₃, and the third width of D₃′ according to an embodiment of the present application. On the basis of the preceding embodiments, referring to FIGS. 13, 18, and 19, in the case where a third length of the first invalid electrode D₃, a third length of the second invalid electrode D₃′, the third length of the third invalid electrode D₁, the third length of the fourth invalid electrode D₁′, the third length of the fifth invalid electrode D₀, the third length of the sixth invalid electrode D₀′, the third length of the seventh invalid electrode D₂, and the third length of the eighth invalid electrode D₂′ are unchanged, with the third width of the first invalid electrode D₃, the third width of the second invalid electrode D₃′, the third width of the third invalid electrode D₁, the third width of the fourth invalid electrode D₁′, the third width of the fifth invalid electrode D₀, the third width of the sixth invalid electrode D₀′, the third width of the seventh invalid electrode D₂, and the third width of the eighth invalid electrode D₂′ increasing, the area of the first invalid electrode D₃, the area of the second invalid electrode D₃′, the area of the third invalid electrode D₁, the area of the fourth invalid electrode D₁′, the area of the fifth invalid electrode D₀, the area of the sixth invalid electrode D₀′, the area of the seventh invalid electrode D₂, and the area of the eighth invalid electrode D₂′ increase. In this case, the area of the first touch sensing sub-region Y₀ of the first electrode 11 and the area of the second touch sensing sub-region Y₀′ of the first electrode 11 reduce; the capacitance-to-ground C_{pY} of the first electrode 11 reduces; the area of the third touch sensing sub-region X₀ of the second electrode 12, the area of the fourth touch sensing sub-region X₀′ of the second electrode 12, the area of the fifth touch sensing sub-region X₁ of the second electrode 12, the area of the sixth touch sensing sub-region X₁′ of the second electrode 12, the area of the seventh touch sensing sub-region X₂ of the second electrode 12, and the area of the eighth touch sensing sub-region X₂′ of the second electrode 12 reduce; the capacitance-to-ground C_{pX} of the second electrode 12 reduces; and the coupling capacitance Cₘ between the first electrode 11 and the second electrode 12 reduces greatly. In conclusion, referring to FIGS. 7, 18, and 19, the first width W₁ is set to be in the range of 150 μm to 300 μm, enabling the coupling capacitance Cₘ between the first electrode 11 and the second electrode 12, the capacitance-to-ground C_{pY} of the first electrode 11 and the capacitance-to-ground C_{pX} of the second electrode 12 to be each in the appropriate range, making the noise of the display panel to the touch panel relatively small, guaranteeing a relatively high sensitivity of the touch sensing signal, and improving the touch effect.

In an embodiment, FIG. 20 is a structural view of a touch display device according to an embodiment of the present application. On the basis of the preceding embodiments, referring to FIG. 20, a touch display device 100 according to this embodiment of the present application includes a layered display panel 200 and the touch panel 300 described in any preceding embodiment and may further include a transparent cover plate 400 disposed on a side of the touch panel 300 facing away from the display panel 200.

What is claimed is:

1. A touch panel, comprising:
a plurality of touch electrodes disposed in a same layer comprising a touch sensing region and a capacitance adjustment region;
wherein the touch sensing region is configured to transmit a touch signal;
the capacitance adjustment region is provided with a floating electrode inside, and the floating electrode is not connected to and is insulated with an adjacent touch electrode; and
the touch sensing region comprises at least two touch sensing sub-regions, the capacitance adjustment region comprises at least two capacitance adjustment sub-regions, and each touch sensing sub-region of the at least two touch sensing sub-regions is correspondingly provided with at least one of the at least two capacitance adjustment sub-regions.

2. The touch panel according to claim 1, wherein the capacitance adjustment region is provided with an invalid electrode, and the invalid electrode is disposed in a same layer as the touch electrode and is floated.

3. The touch panel according to claim 1, wherein the touch sensing region is disposed around the capacitance adjustment region.

4. The touch panel according to claim 3, wherein a first length of the capacitance adjustment region is smaller than a second length of the touch sensing region, and a first width of the capacitance adjustment region is smaller than a second width of the touch sensing region, wherein the first length is a size of a long side of the capacitance adjustment region, the second length is a size of a long side of the touch sensing region, the first width is a size of a short side of the capacitance adjustment region, and the second width is a size of a short side of the touch sensing region.

5. The touch panel according to claim 4, wherein a distance between a side of the touch sensing region adjacent to a side of the capacitance adjustment region and a corresponding side of the capacitance adjustment region is greater than or equal to 50 μm, and the first width is in a range of 150 μm to 300 μm.

6. The touch panel according to claim 2, wherein a shape of the invalid electrode comprises at least one of a rectangle, a triangle, a regular hexagon, or a circle.

7. The touch panel according to claim 1, wherein the touch panel is a mutual capacitance touch panel, and the touch electrode comprises a first electrode, wherein the first electrode comprises the touch sensing region and the capacitance adjustment region.

8. The touch panel according to claim 1, wherein the touch panel is a mutual capacitance touch panel, and the touch electrode comprises a second electrode, wherein the second electrode comprises the touch sensing region and the capacitance adjustment region.

9. The touch panel according to claim 1, wherein the capacitance adjustment region is hollowed out.

10. The touch panel according to claim 1, wherein the capacitance adjustment region is filled with an insulating layer.

11. The touch panel according to claim 1, wherein the touch panel is a self-capacitance touch panel.

12. The touch panel according to claim 1, wherein a shape of the capacitance adjustment region is the same as or different from a shape of the touch electrode.

13. The touch panel according to claim 1, wherein the plurality of touch electrodes comprise a first electrode and a second electrode;
the first electrode comprises two touch sensing sub-regions, which are a first touch sensing sub-region and a second touch sensing sub-region;
the second electrode comprises six touch sensing sub-regions, which are a third touch sensing sub-region, a fourth touch sensing sub-region, a fifth touch sensing sub-region, a sixth touch sensing sub-region, a seventh touch sensing sub-region, and an eighth touch sensing sub-region; and
each touch sensing sub-region is correspondingly provided with one capacitance adjustment sub-region; and each capacitance adjustment sub-region includes one invalid electrode.

14. The touch panel according to claim 13, wherein
the first touch sensing sub-region and the second touch sensing sub-region are correspondingly provided with a first invalid electrode and a second invalid electrode respectively;
the third touch sensing sub-region and the fourth touch sensing sub-region are correspondingly provided with a third invalid electrode and a fourth invalid electrode respectively;
the fifth touch sensing sub-region and the sixth touch sensing sub-region are correspondingly provided with a fifth invalid electrode and a sixth invalid electrode respectively; and
the seventh touch sensing sub-region and the eighth touch sensing sub-region are correspondingly provided with a seventh invalid electrode and an eighth invalid electrode respectively.

15. The touch panel according to claim 14, wherein
a third width of the first invalid electrode, a third width of the second invalid electrode, a third width of the third invalid electrode, a third width of the fourth invalid electrode, a third width of the fifth invalid electrode, a third width of the sixth invalid electrode, a third width of the seventh invalid electrode and a third width of the eighth invalid electrode are adjusted so as to adjust the area of corresponding invalid electrodes, thereby adjusting the area of the first electrode in a corresponding region and the area of the second electrode in a corresponding region.

16. A touch display device, comprising: a layered display panel and the touch panel according to claim 1.

17. The touch display device according to claim 16, further comprising: a transparent cover plate, wherein the transparent cover plate is disposed on a side of the touch panel facing away from the display panel.

18. The touch display device according to claim 16, wherein the plurality of touch electrodes comprise a first electrode and a second electrode;
the first electrode comprises two touch sensing sub-regions, which are a first touch sensing sub-region and a second touch sensing sub-region;
the second electrode comprises six touch sensing sub-regions, which are a third touch sensing sub-region, a fourth touch sensing sub-region, a fifth touch sensing sub-region, a sixth touch sensing sub-region, a seventh touch sensing sub-region, and an eighth touch sensing sub-region; and
each touch sensing sub-region is correspondingly provided with one capacitance adjustment sub-region; and each capacitance adjustment sub-region includes one invalid electrode.

19. The touch display device according to claim 18, wherein
the first touch sensing sub-region and the second touch sensing sub-region are correspondingly provided with a first invalid electrode and a second invalid electrode respectively;
the third touch sensing sub-region and the fourth touch sensing sub-region are correspondingly provided with a third invalid electrode and a fourth invalid electrode respectively;
the fifth touch sensing sub-region and the sixth touch sensing sub-region are correspondingly provided with a fifth invalid electrode and a sixth invalid electrode respectively; and
the seventh touch sensing sub-region and the eighth touch sensing sub-region are correspondingly provided with a seventh invalid electrode and an eighth invalid electrode respectively.

20. The touch display device according to claim 19, wherein
a third width of the first invalid electrode, a third width of the second invalid electrode, a third width of the third invalid electrode, a third width of the fourth invalid electrode, a third width of the fifth invalid electrode, a third width of the sixth invalid electrode, a third width of the seventh invalid electrode and a third width of the eighth invalid electrode are adjusted so as to adjust the area of corresponding invalid electrodes, thereby adjusting the area of the first electrode in a corresponding region and the area of the second electrode in a corresponding region.
